(19) United States
(12) Patent Application Publication
(10) Pub. No.: US 2022/0198881 A1
(43) Pub. Date: Jun. 23, 2022

(54) PUZZLE GAME WITH BANKING OF PLAYER ERROR

(71) Applicant: Green Jade Games Ltd, Ta' Xbiex (MT)

(72) Inventors: Jesper Karrbrink, Stockholm (SE); Benedict McDonagh, Ta'Xbiex (MT)

(73) Assignee: Green Jade Games Ltd, Ta' Xbiex (MT)

(21) Appl. No.: 16/917,781

(22) Filed: Jun. 30, 2020

(51) Int. Cl. G07F 17/32

(52) U.S. Cl. CPC G07F 17/3295; G07F 17/3209; G07F 17/3258; G07F 17/3262; G07F 17/3213

(57) ABSTRACT

A method, system, and computer readable storage to implement an electronic puzzle mechanic. The mechanic enables a player to place pieces on a grid. The pieces can be rotated before placement. Upon forming a line, either horizontally or vertically, the pixels in the line are removed from the grid and the player earns both points and potentially credits.

### BACKGROUND OF THE INVENTION

### Field of the Invention

The present general inventive concept is directed to a method, apparatus, and computer readable storage medium directed to a video game apparatus, method, and computer readable storage which can implement a puzzle.

### Description of the Related Art

Video games (played online, on ‘apps’ (such as on mobile phones, tablets, etc.) or played on electronic gaming machines are a billion dollar industry. Once such genre of games are “nonstop” games in which targets will move vertically from the top of the screen to the bottom of the screen and the player has to destroy all of the targets by shooting them before a target moves below a horizontal line on the screen. Once a target passes the horizontal line, the game ends.

Video games which allow for wagering of real money are also becoming more popular as the two genres (video games, gambling games) are being merged together.

### SUMMARY OF THE INVENTION

It is an aspect of the present invention to provide an improved video game for wagering.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is an example of different systems in which the methods described herein can be played (applied), according to an embodiment;

FIG. 2 is a drawing showing a first stage of an interactive mechanic, according to an embodiment;

FIG. 3 is a drawing showing a second stage of an interactive mechanic, according to an embodiment;

FIG. 4 is a drawing showing a third stage of an interactive mechanic, according to an embodiment;

FIG. 5 is a drawing showing a fourth stage of an interactive mechanic, according to an embodiment;

FIG. 6 is a drawing showing a fifth stage of an interactive mechanic, according to an embodiment;

FIG. 7 is a drawing showing a sixth stage of an interactive mechanic, according to an embodiment;

FIG. 8 is a drawing showing a seventh stage of an interactive mechanic, according to an embodiment;

FIG. 9 is a drawing showing an eighth stage of an interactive mechanic, according to an embodiment;

FIG. 10 is a drawing showing a ninth stage of an interactive mechanic, according to an embodiment;

FIG. 11 is a drawing showing a tenth stage of an interactive mechanic, according to an embodiment;

FIG. 12 is a drawing showing an eleventh stage of an interactive mechanic, according to an embodiment;

FIG. 13 is a drawing showing a twelfth stage of an interactive mechanic, according to an embodiment;

FIG. 14 is a drawing showing a thirteenth stage of an interactive mechanic, according to an embodiment;

FIG. 15 is a drawing showing a fourteenth stage of an interactive mechanic, according to an embodiment;

FIG. 16 is a drawing showing a fifteenth stage of an interactive mechanic, according to an embodiment;

FIG. 17 is a drawing showing a sixteenth stage of an interactive mechanic, according to an embodiment;

FIG. 18 is a drawing showing a seventeenth stage of an interactive mechanic, according to an embodiment;

FIG. 19 is a drawing showing an eighteenth stage of an interactive mechanic, according to an embodiment;

FIG. 20 is a drawing showing a nineteenth stage of an interactive mechanic, according to an embodiment;

FIG. 21 is a drawing showing a twentieth stage of an interactive mechanic, according to an embodiment;

FIG. 22 is a drawing showing a twenty-first stage of an interactive mechanic, according to an embodiment;

FIG. 23 is a drawing showing a twenty-second stage of an interactive mechanic, according to an embodiment;

FIG. 24 is a drawing showing a twenty-third stage of an interactive mechanic, according to an embodiment;

FIG. 25 is a drawing showing a twenty-fourth stage of an interactive mechanic, according to an embodiment;

FIG. 26 is a drawing showing a twenty-fifth stage of an interactive mechanic, according to an embodiment;

FIG. 27 is a drawing showing a twenty-sixth stage of an interactive mechanic, according to an embodiment;

FIG. 28 is a drawing showing a twenty-seventh and last stage of an interactive mechanic, according to an embodiment;

FIG. 29 is a flowchart illustrating an exemplary method of implementing a puzzle game, according to an embodiment;

FIG. 30 is a flowchart illustrating an exemplary method of determining awards for forming a line, according to an embodiment;

FIG. 31 is a drawing of a set of potential shapes, according to an embodiment;

FIG. 32 is a block diagram illustrating exemplary hardware that can be used to implement the game described herein, according to an embodiment; and

FIG. 33 is a network diagram showing a network structure for an online casino and players, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The general inventive concept relates to a video game which enables the player to place a wager in coins, play the game, and then potentially win coins based on what has taken place during the game. The game involves placing shapes into a grid. The game incorporates error banking (as described below) so that players who do not play optimally will have their error contributed to an error pool with players who play optimally will win the error pool.

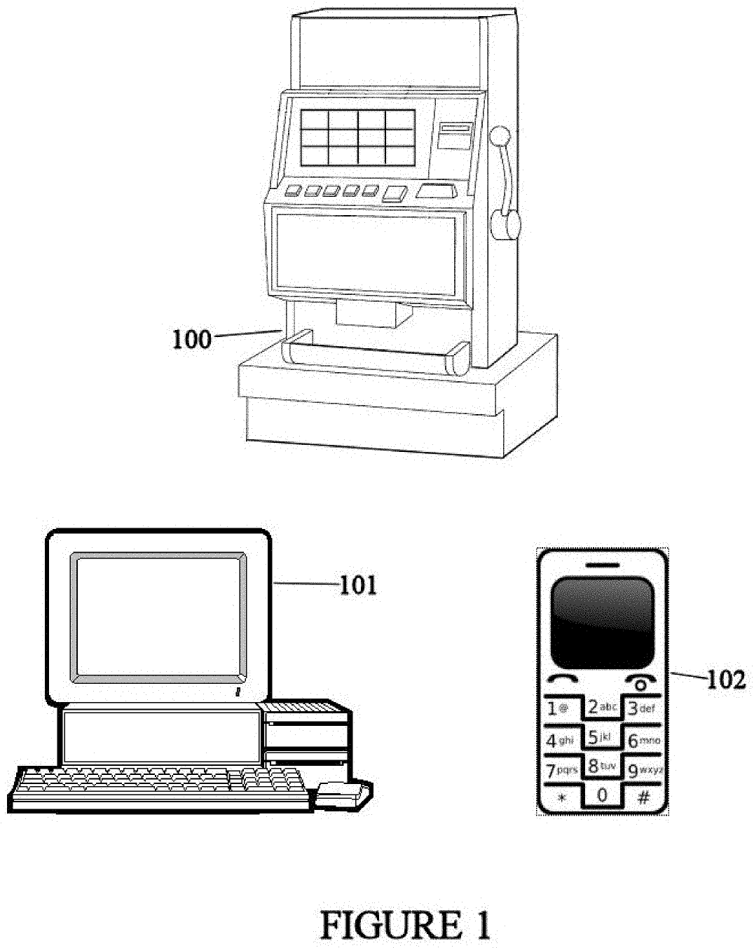

FIG. 1 is an example of different systems in which the methods described herein can be played (applied), according to an embodiment. The game described herein can be played by players on a typical electronic gaming machine (e.g., slot machine), a personal computer (or laptop) 101, or a cell (mobile) phone 102. Each of these devices would be connected to a network which would be connected to a server 500. The connection can be via a physical LAN, wireless connection (e.g., WIFI, Bluetooth, etc.) simple cables, etc.

The game (mechanic) enables a player to place shapes in a grid. Whenever a horizontal or vertical line is present in the grid, the line will disappear and the player will be awarded points. The goal of the player is to earn as many points as possible before the player cannot place another piece on the grid (which ends the game).

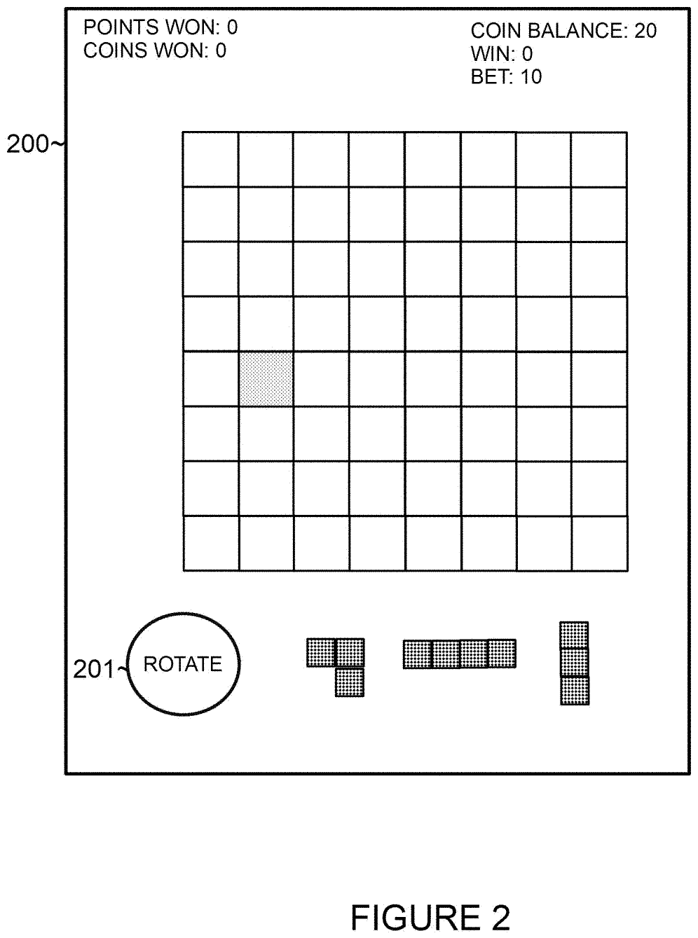

Note that FIGS. 2 to 27 illustrate one example play of the game, although it can be appreciated that this is just one example and there are a large number of other instances of the game as well. Each of FIGS. 2-27 occur in time sequence.

FIG. 2 is a drawing showing a first stage of an interactive mechanic, according to an embodiment.

The game starts out with a blank grid (8 by 8 or any other dimensions) of on/off pixels. On the bottom are three available shapes to place in the grid. The shapes must “snap” to exactly a place in the grid (e.g., a shape cannot be placed between lines on the grid). The player can select one of the three shapes and drag it on to a place on the grid.

Note that the game screen shows a quantity of points on and a quantity of coins won. These are two separate quantities that can be earned in the game. Coins (in an embodiment) have real cash value and the player would typically try to win as many coins as possible. Points have no cash value and are used for entertainment purposes. “Points won” represents how many points were won in the current game. “Coins won” represents how many coins were won in the current game. “Coin Balance” represents how many coins the player current has (this can also be considered the “credit meter”). “Win” represents how many coins were won on the last line formed. “Bet” represents how many coins the player has bet on the current game.

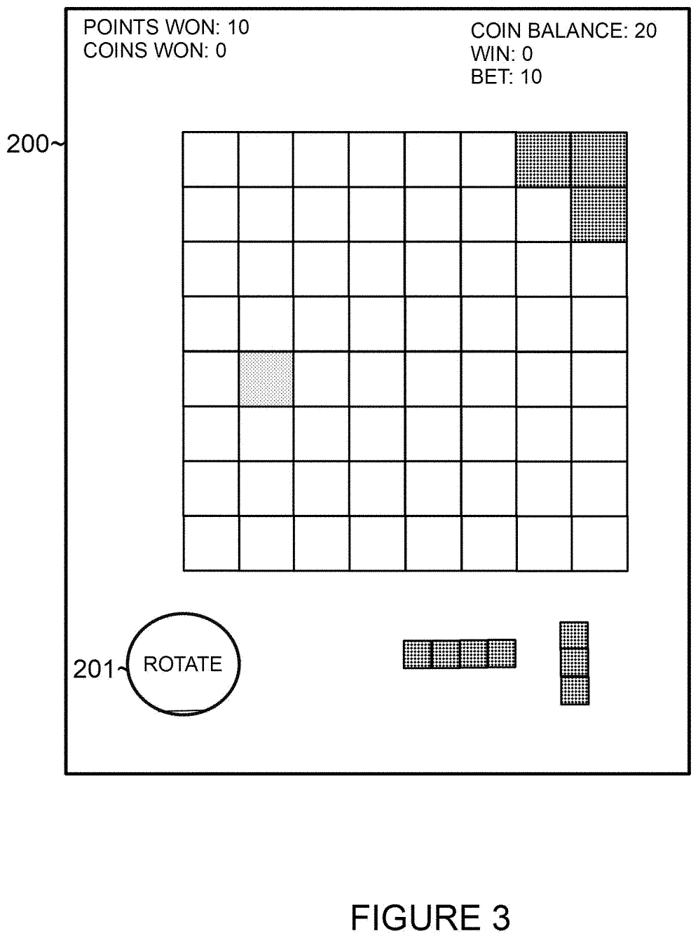

FIG. 3 is a drawing showing a second stage of an interactive mechanic, according to an embodiment.

The player has selected the “corner” shape and placed it in the upper right of the grid. The player can select pieces by touching (or clicking, etc.) and dragging it to its desired place on the grid. The player cannot place a piece over a part of the grid which already has another shape there. In other words, a player can only place a shape (piece) on the grid in a position which covers only white pixels (representing empty space).

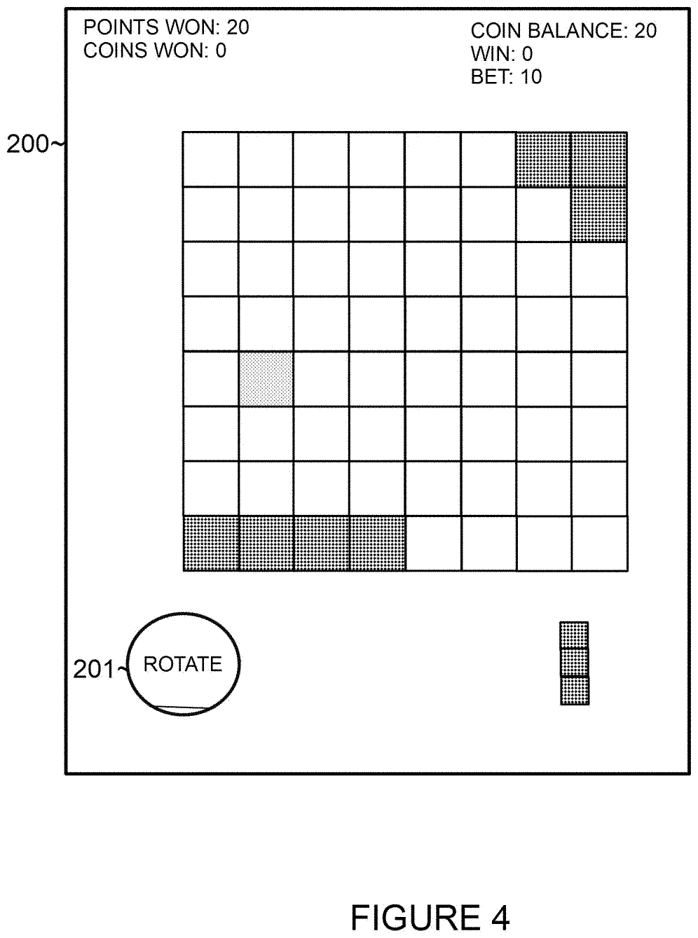

FIG. 4 is a drawing showing a third stage of an interactive mechanic, according to an embodiment.

The player drags another piece onto the grid. As each piece on the bottom is placed inside the grid, it is no longer available on the bottom to be selected.

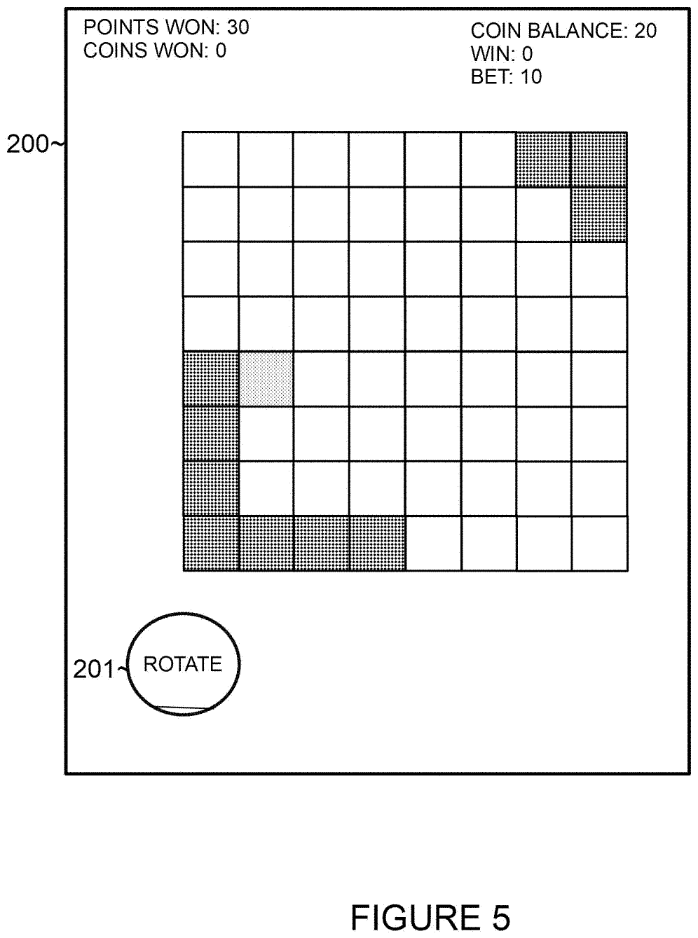

FIG. 5 is a drawing showing a fourth stage of an interactive mechanic, according to an embodiment.

The player selects the remaining shape (piece) on the bottom and places it in the grid. There are no more shapes on the bottom at this point to be selected.

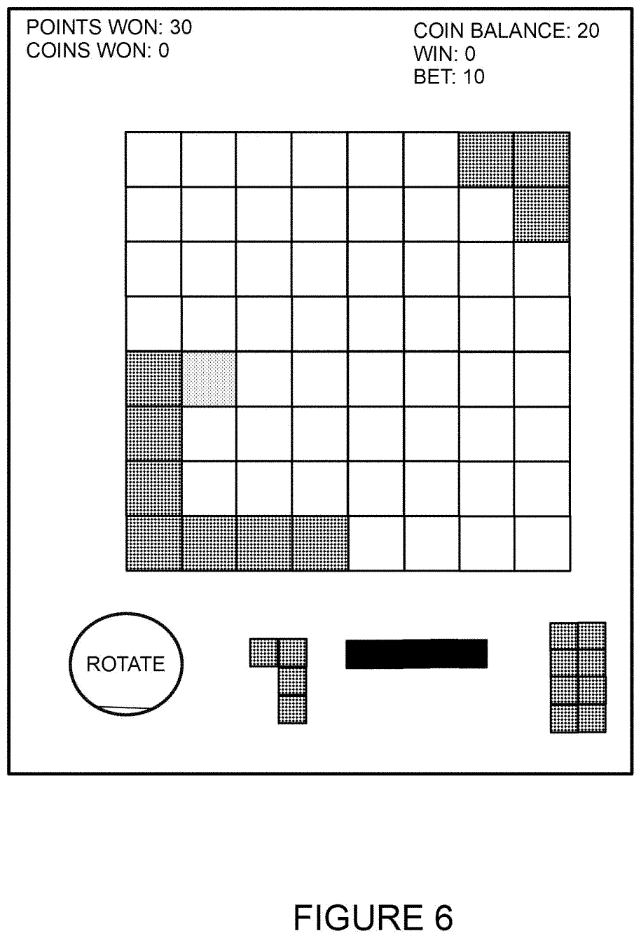

FIG. 6 is a drawing showing a fifth stage of an interactive mechanic, according to an embodiment.

Because there are no further shapes on the bottom of the screen to select, three new shapes automatically appear on the bottom. The shapes displayed are selected randomly from a library of potential shapes. Note that shapes can have two possible colors, gray or black (but of course any other color combinations can be used). In this example, black shapes are better for the player in that the black shapes can earn the player coins. Gray shapes can earn the player points but not coins. Whether a shape is black or gray is determined randomly, although most shapes will be gray instead of black (for example a shape can have a ⅕ chance of being black otherwise it is gray).

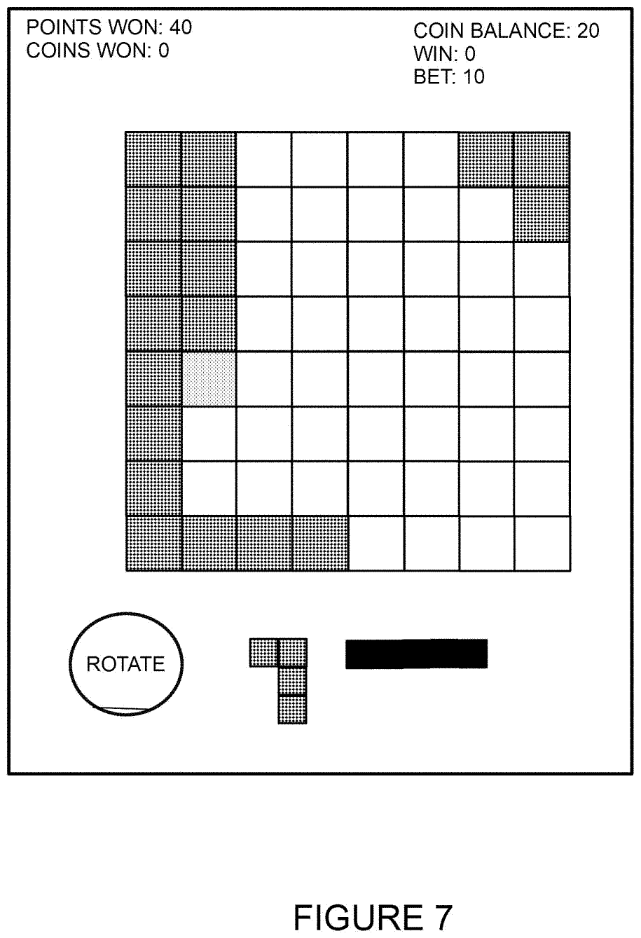

FIG. 7 is a drawing showing a sixth stage of an interactive mechanic, according to an embodiment.

The player places the (gray) rectangle shape in the upper left of the grid. This forms a vertical line in the first column of the grid. All pixels in each line formed will automatically disappear (be removed).

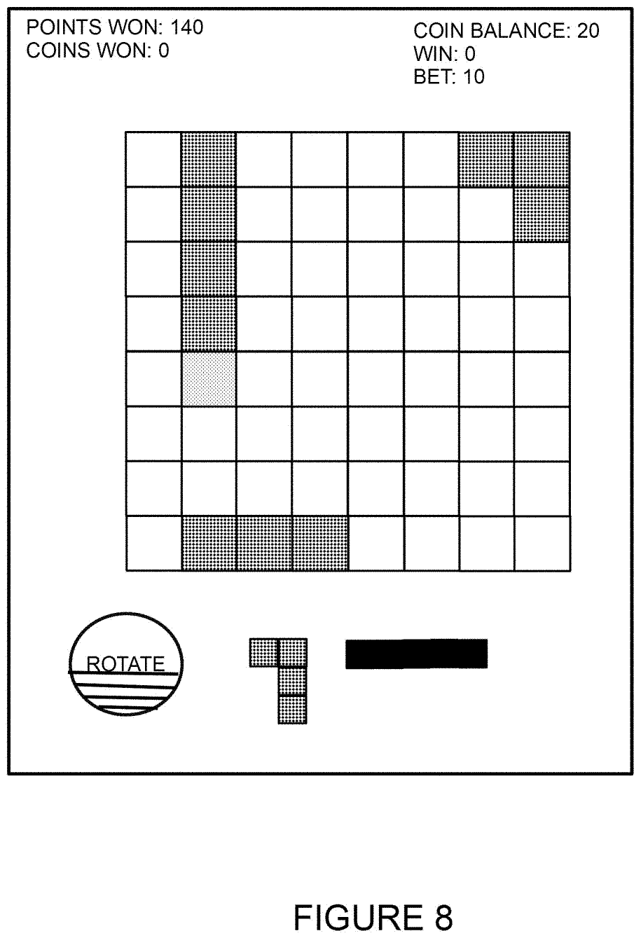

FIG. 8 is a drawing showing a seventh stage of an interactive mechanic, according to an embodiment.

Note that all of the pixels in the first column have disappeared (turned white) because a line in the first column was formed. Note the player also earns points for each line formed as well.

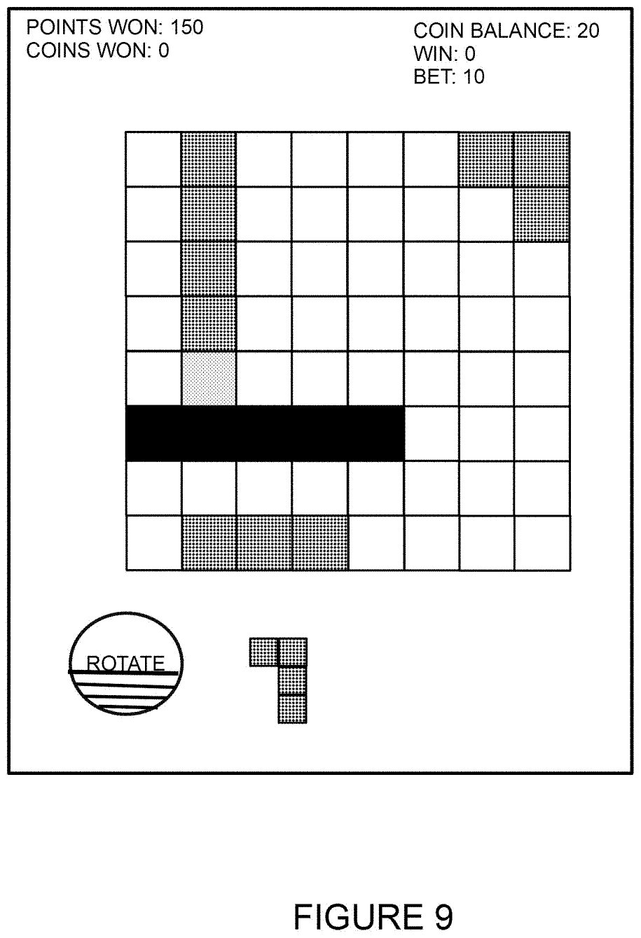

FIG. 9 is a drawing showing an eighth stage of an interactive mechanic, according to an embodiment.

The player places the black shape.

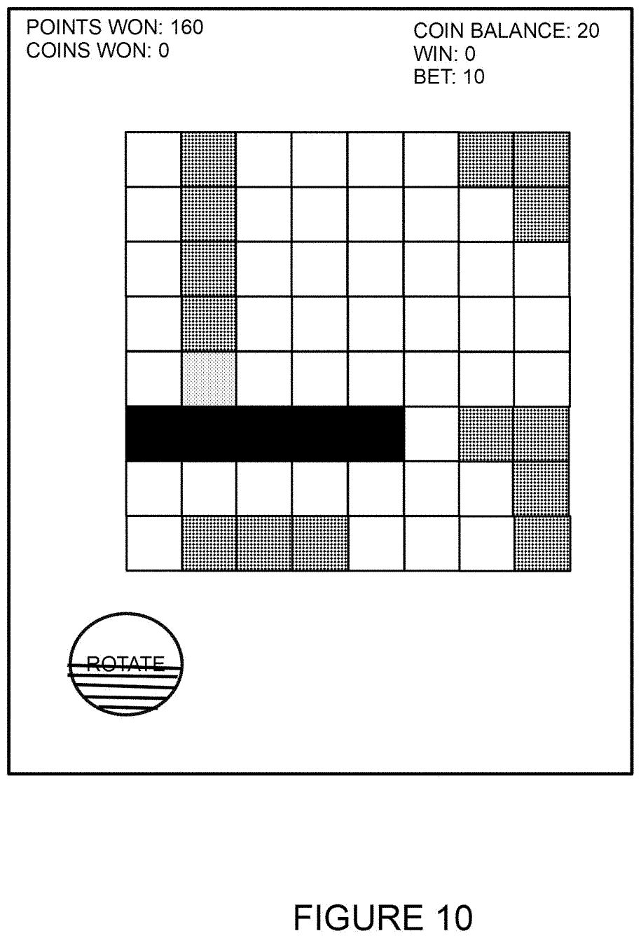

FIG. 10 is a drawing showing a ninth stage of an interactive mechanic, according to an embodiment.

The player places the remaining ‘L’ shaped piece (shape).

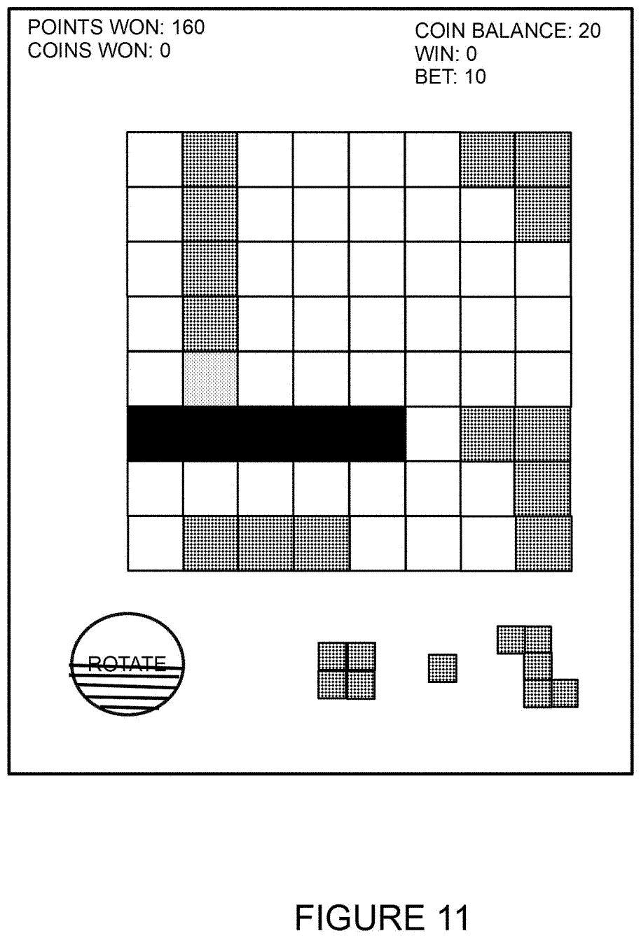

FIG. 11 is a drawing showing a tenth stage of an interactive mechanic, according to an embodiment.

Three new random shapes are selected and displayed on the bottom for the player to place.

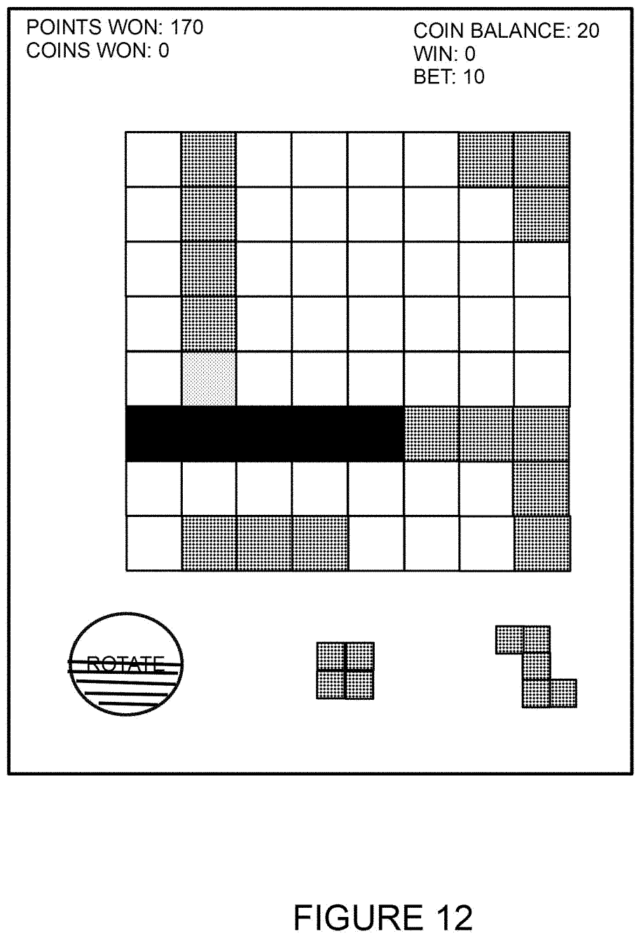

FIG. 12 is a drawing showing an eleventh stage of an interactive mechanic, according to an embodiment.

The player places the single-pixel shape in the grid, forming a horizontal line.

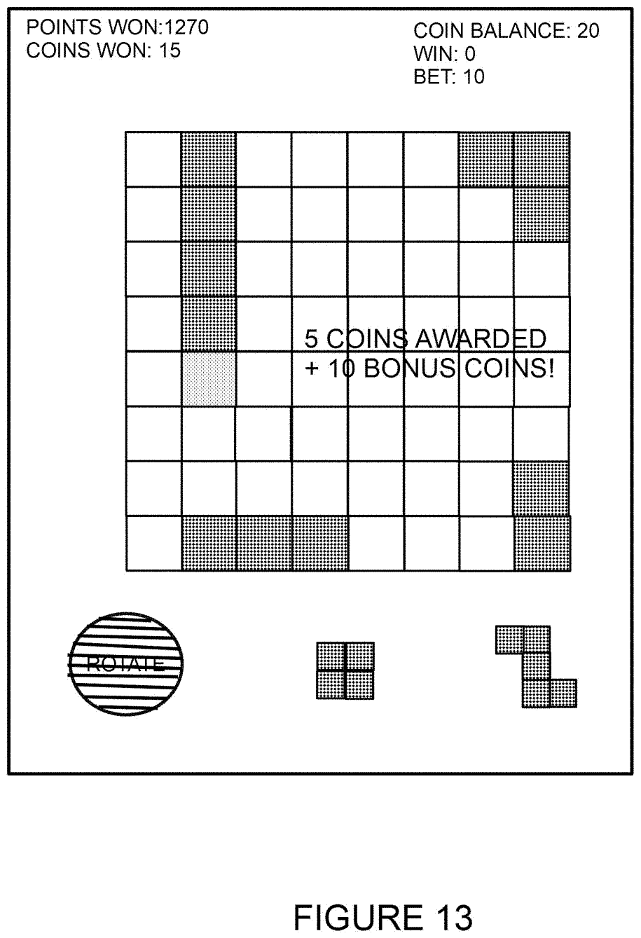

FIG. 13 is a drawing showing a twelfth stage of an interactive mechanic, according to an embodiment.

The horizontal line disappears. Because of the horizontal line that was formed (and removed), the player earns both points and coins. Note that because the entire last piece that was placed (the single pixel) was eliminated in the line made, the player wins a bonus of 1,000 points. Coins are redeemable for cash and thus the player wants to earn as many coins as possible.

Note that 5 black (not gray) pixels were removed in the line that was formed. Since each black pixel is worth one coin, the player is awarded five coins for the line. In addition, the game awarded the player a bonus of 10 coins, totaling 15 coins that the player has earned for making this line. The bonus coins are taken from the bonus pool according to a bonus distribution, as described herein.

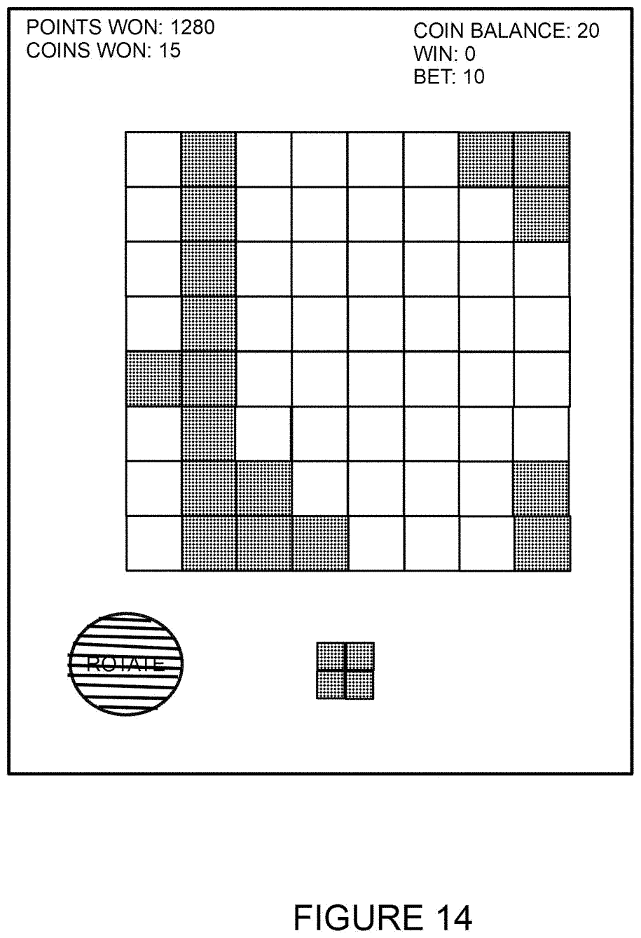

FIG. 14 is a drawing showing a thirteenth stage of an interactive mechanic, according to an embodiment.

The player places the “zig-zag” shape on the grid, forming a vertical line of only gray pixels.

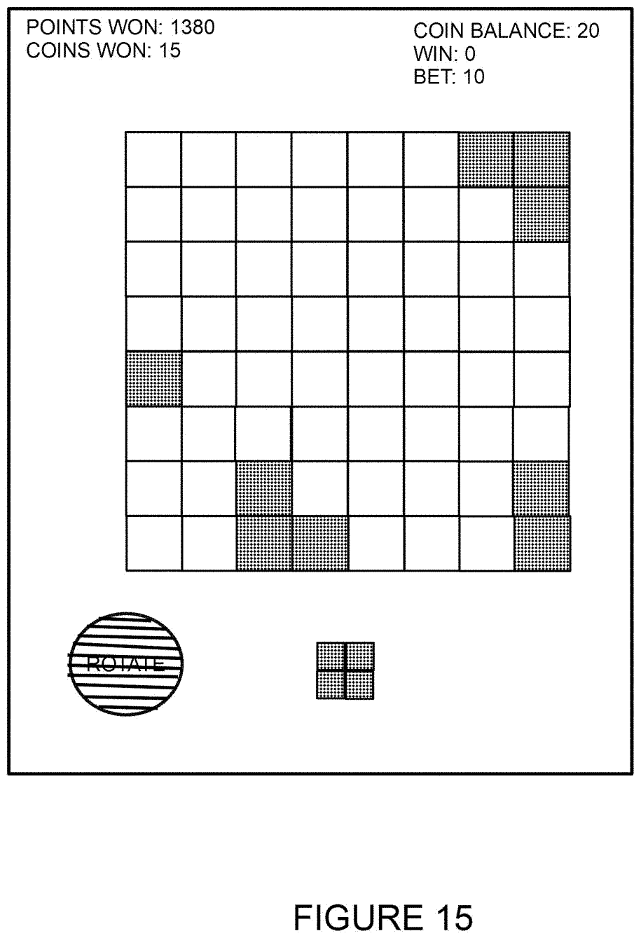

FIG. 15 is a drawing showing a fourteenth stage of an interactive mechanic, according to an embodiment.

The vertical line in the second column is removed, and the player earns more points. Note that no black pixels are in this line and thus no coins are earned.

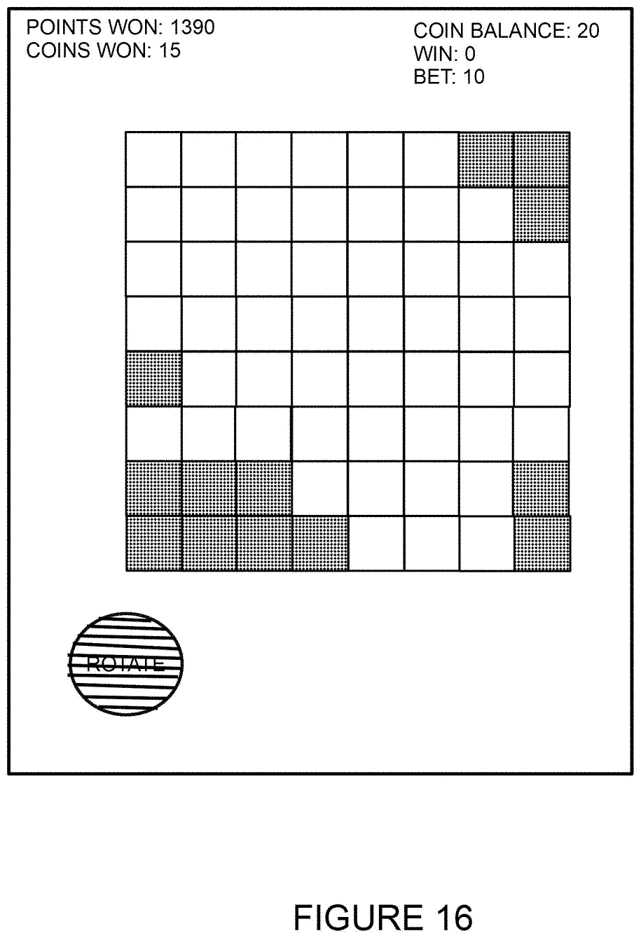

FIG. 16 is a drawing showing a fifteenth stage of an interactive mechanic, according to an embodiment.

The player places the box shape in the lower left corner of the grid.

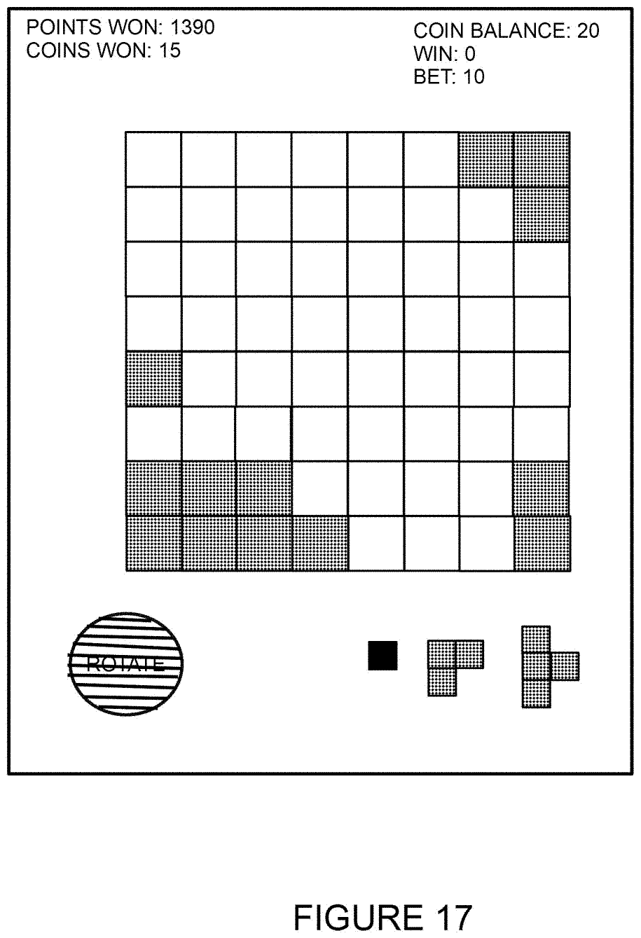

FIG. 17 is a drawing showing a sixteenth stage of an interactive mechanic, according to an embodiment.

The player is presented with three new shapes on the bottom to place.

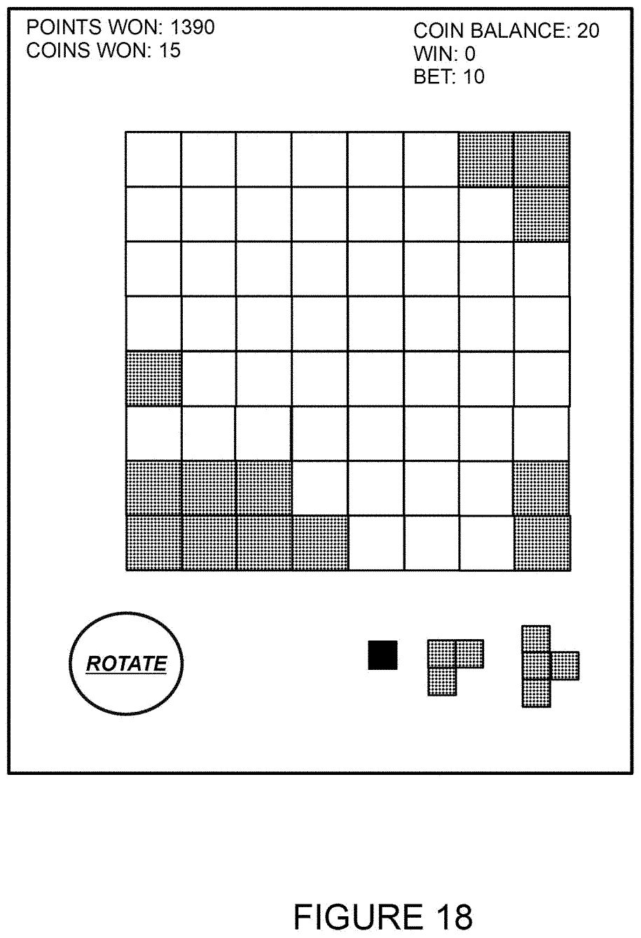

FIG. 18 is a drawing showing a seventeenth stage of an interactive mechanic, according to an embodiment.

The player desires to rotate a piece and presses the “rotate” button.

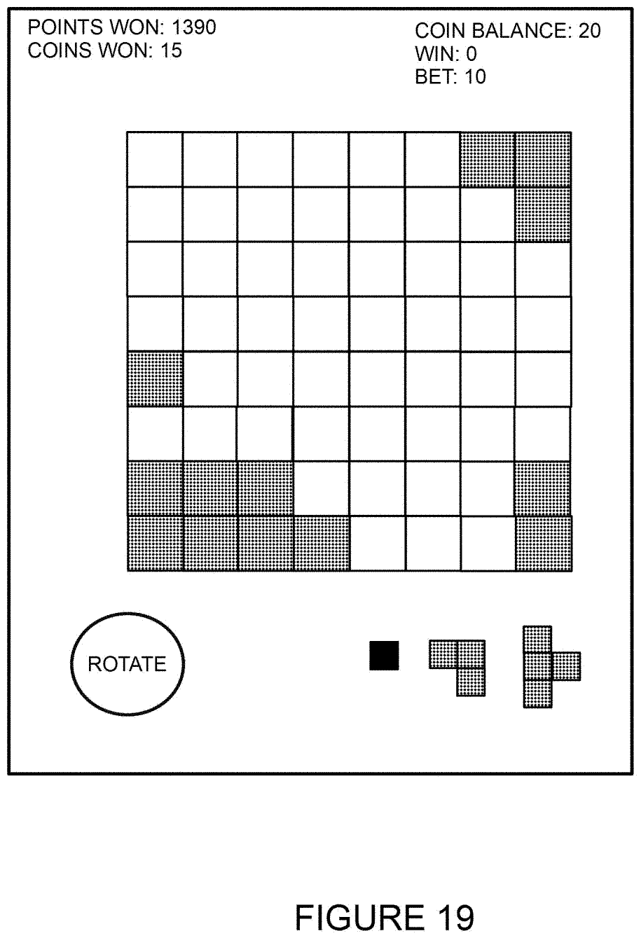

FIG. 19 is a drawing showing an eighteenth stage of an interactive mechanic, according to an embodiment.

The player touches the middle shape (“corner”-shape) and rotates it (it rotates 90 degrees counterclockwise). The player is free to rotate the touched piece as many times as he/she wants until it is in the desired position. Note that the player can only rotate one piece.

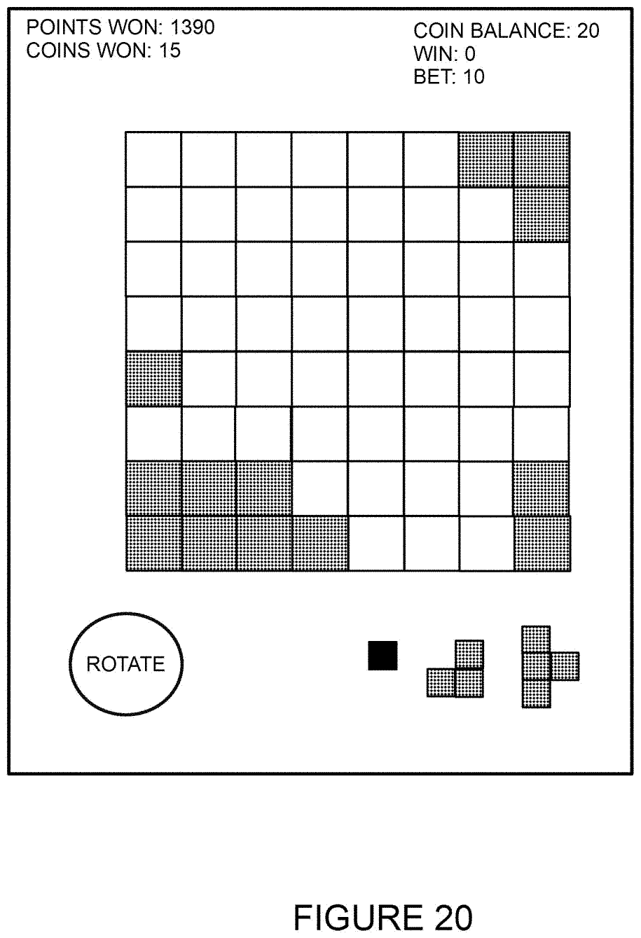

FIG. 20 is a drawing showing a nineteenth stage of an interactive mechanic, according to an embodiment.

The player rotates the middle piece again.

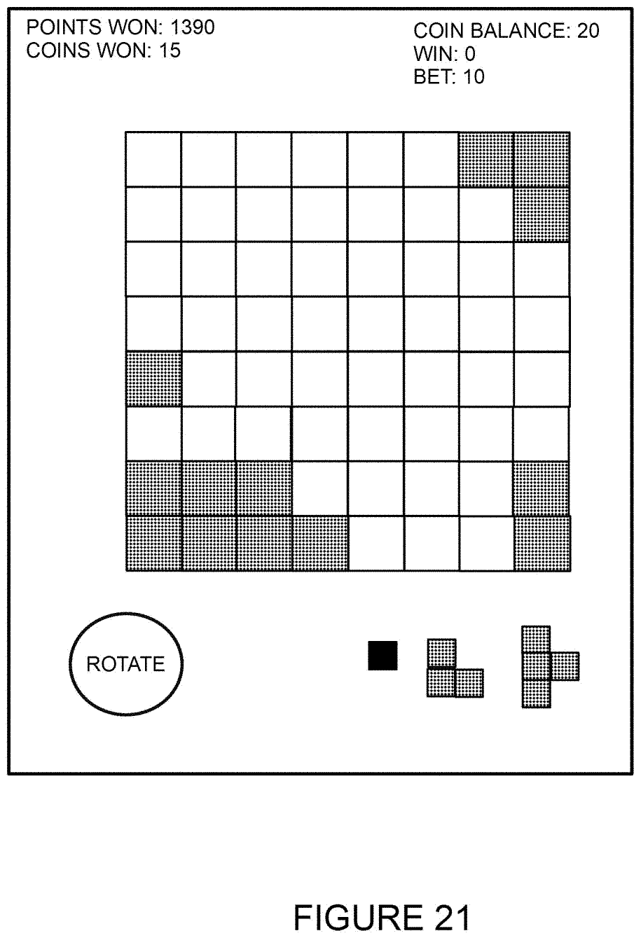

FIG. 21 is a drawing showing a twentieth stage of an interactive mechanic, according to an embodiment.

The player rotates the middle piece yet again.

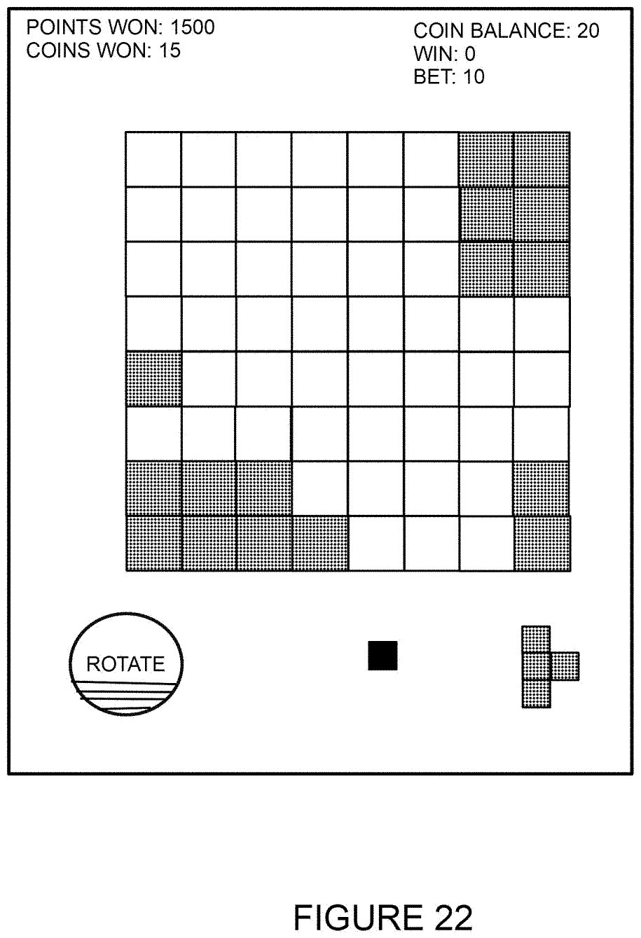

FIG. 22 is a drawing showing a twenty-first stage of an interactive mechanic, according to an embodiment.

The player places the middle piece (in its rotated state) onto the grid. Note that the player receive a 100 point bonus for placing a rotated piece on the grid.

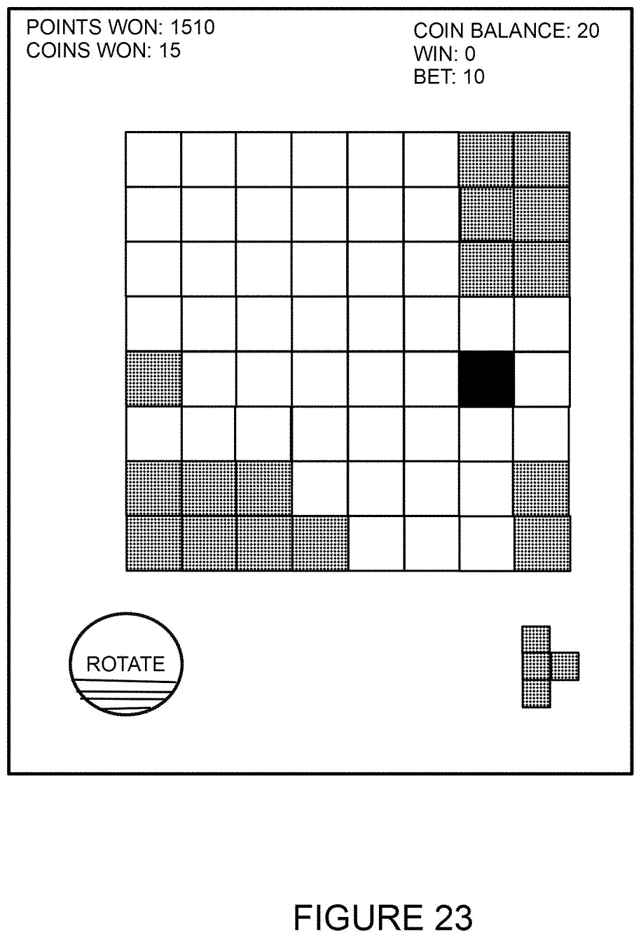

FIG. 23 is a drawing showing a twenty-second stage of an interactive mechanic, according to an embodiment.

The player places the black pixel shape onto the grid.

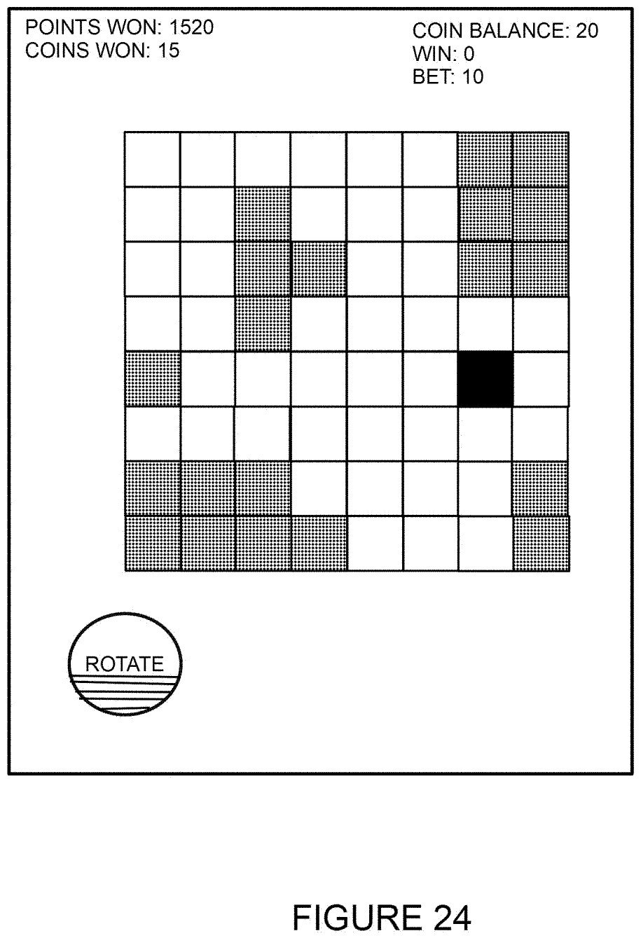

FIG. 24 is a drawing showing a twenty-third stage of an interactive mechanic, according to an embodiment.

The player places the remaining shape onto the grid.

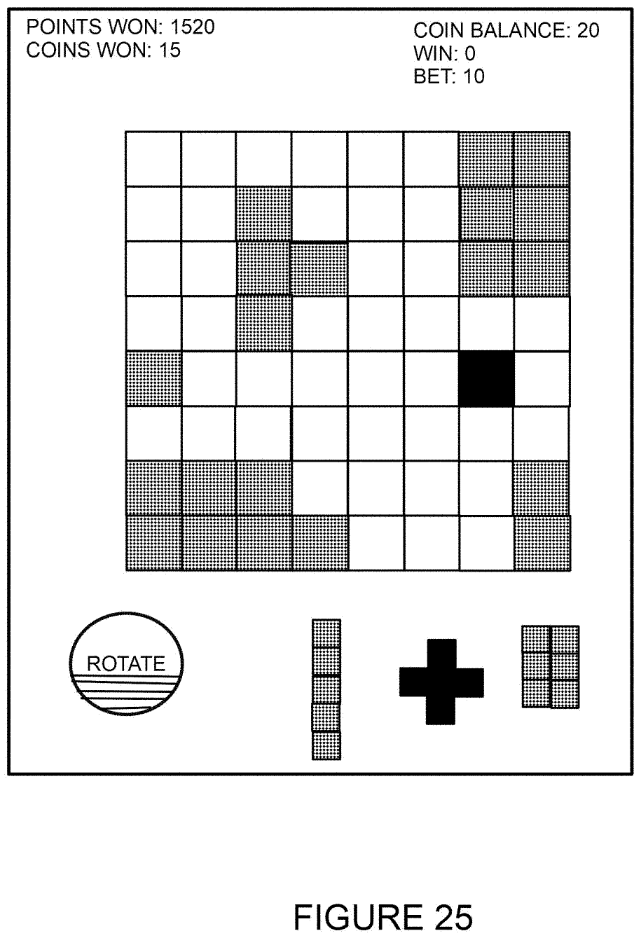

FIG. 25 is a drawing showing a twenty-fourth stage of an interactive mechanic, according to an embodiment.

Three new random shapes are displayed on the bottom for the player to place.

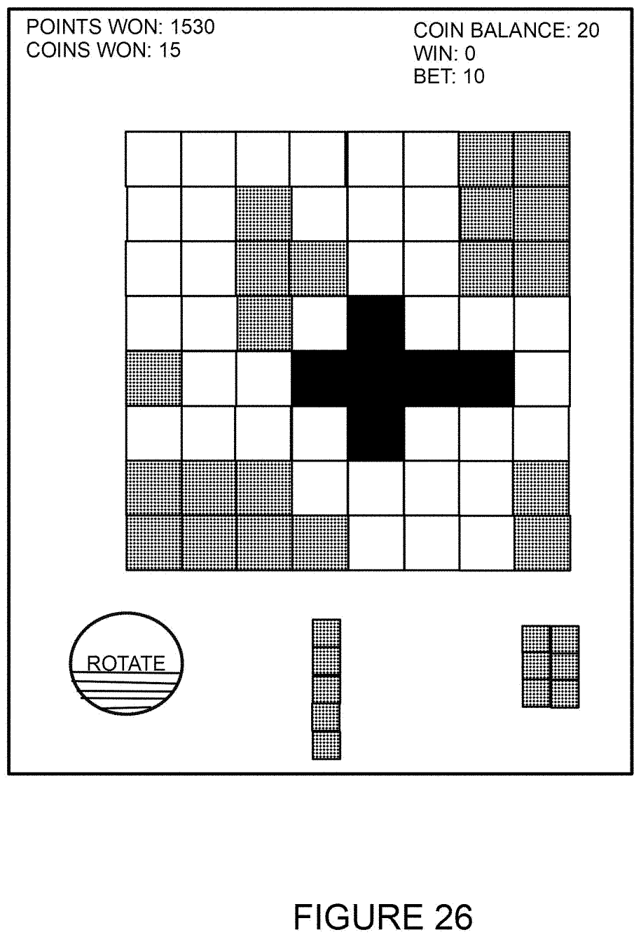

FIG. 26 is a drawing showing a twenty-fifth stage of an interactive mechanic, according to an embodiment.

The player places the black “plus-sign” shape onto the grid.

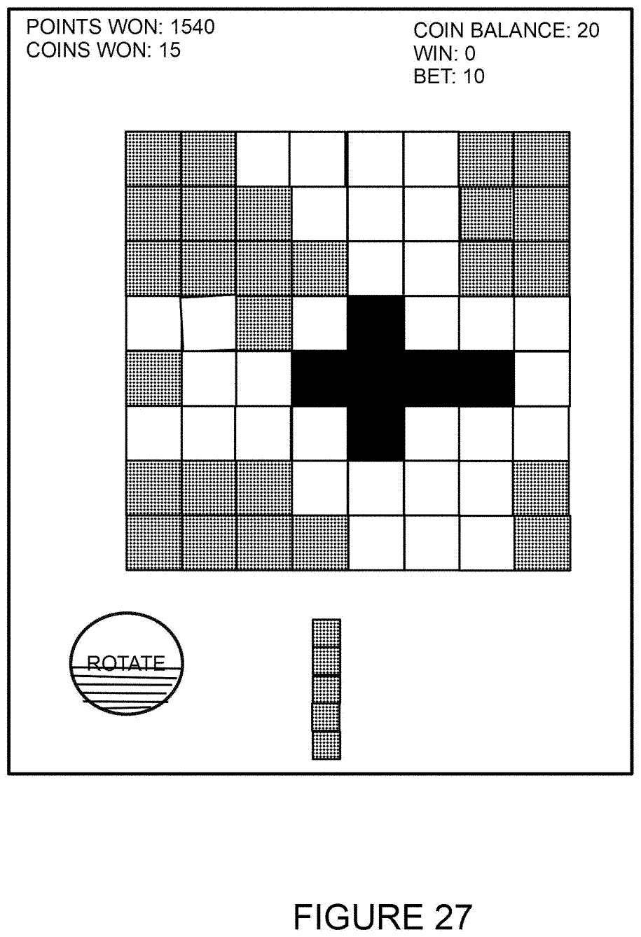

FIG. 27 is a drawing showing a twenty-sixth stage of an interactive mechanic, according to an embodiment.

The player places the rectangle-shape onto the upper left.

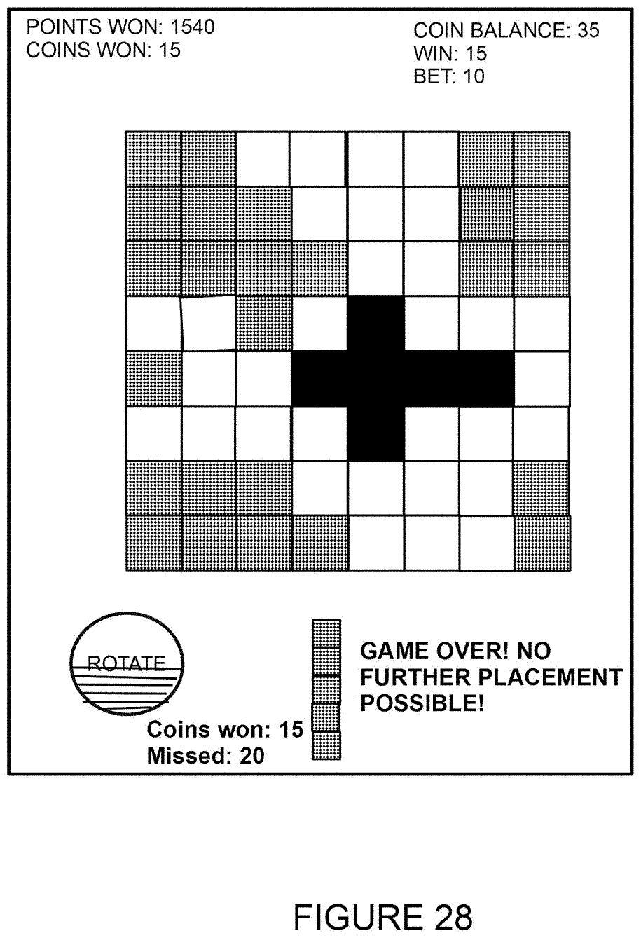

FIG. 28 is a drawing showing a twenty-seventh and last stage of an interactive mechanic, according to an embodiment.

The system automatically determines that the player has no further moves, in other words the player cannot place any of the remaining pieces on the grid. The only remaining piece is the 5-pixel line-shaped piece and there is no place for this piece to go. If the player had a rotation left and any available piece would fit on the grid if rotated then the game would not end. But in this case, there is no possible way the player can place any available piece, so the game now ends. Of course, had the player been more careful in his/her choice of where to place the previous pieces, the player would have been able to place this particular piece and continue the game.

Note that since the game is over, the output device displays the number of coins won (15) which is added to the player's credit meter (“COIN BALANCE”). Also displayed it he number of missed coins (20), in other words the additional coins the player could have won if the player played optimally (the game didn't end until the player won all of the available (35) coins). Since there are 20 missed coins and the player won 15 coins, this means there are 35 total coins the player could have won if the player played optimally and earned all possible coins. From Table I, in this particular game the player was determined to have 35 total coins (this distribution has a 1% probability so the player was lucky to receive this amount).

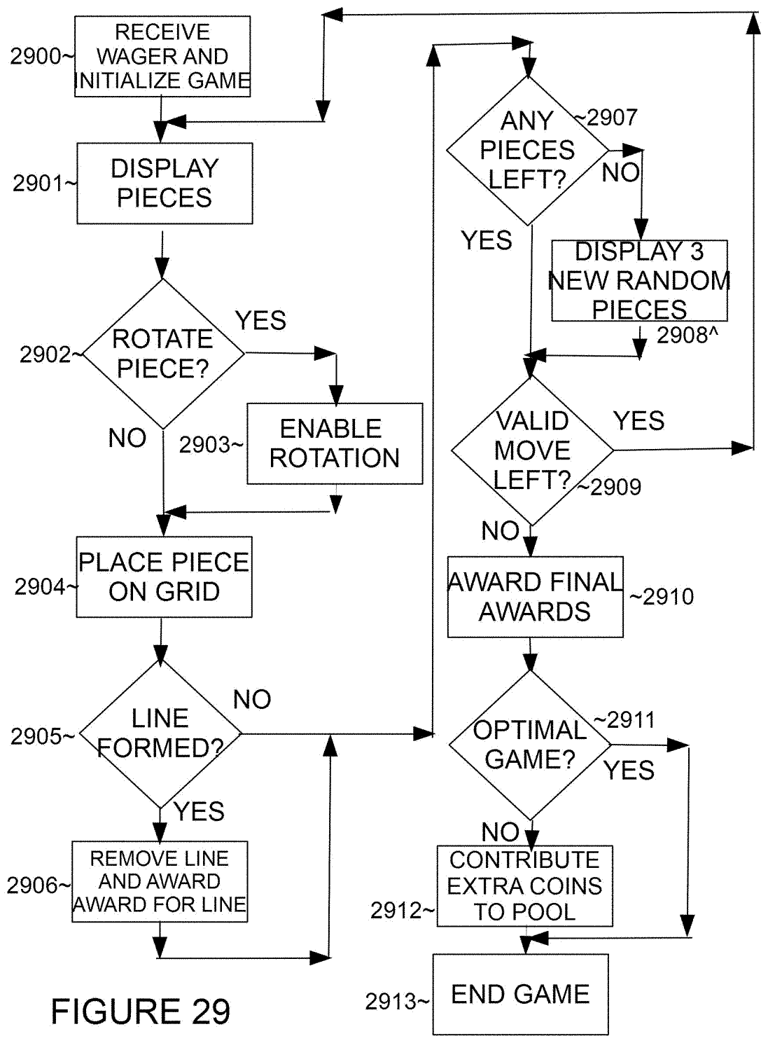

FIG. 29 is a flowchart illustrating an exemplary method of implementing a puzzle game, according to an embodiment.

The method can begin with operation 2900, which receives a wager from a player. The wager can be in coins, in one embodiment, the coins can represent real cash (e.g., players can purchase coins with real cash and also redeem (cash out) coins for real cash). In another embodiment, the coins are non-cash value coins and have no cash value and are only used for entertainment value. The player is required to make a wager in order to play the game (continue to operation 2901).

Note that when the game begins and is initialized, a random number of black pixels is determined. Each piece is made up of pixels (e.g., square blocks). Thus a 3-pixel line that is black contains three black pixels. Each black pixel (as discussed herein) enables the player to earn coins when a line is placed. Thus, a random number of black (can be any other color, such as gold, etc.) pixels is determined which represents the optimal number of coins the player can earn in the game if the player plays optimally. For example, if 20 black pixels are going to be presented to the player as pieces and the player uses all 20 black pixels to make lines then the player has played optimally and earned 20 coins. In one embodiment, all of the pieces that are available to the player are predetermined (including which pieces are black) so the number of black pixels can easily be determined. In another embodiment, the number of black pixels is randomly determined (predetermined) and which pieces are black are randomly determined until the predetermined number of black pixels is reached and then all pieces thereafter are not black. So eventually, during play, if the player can play long enough without the game ending, the player would form lines using all of the black pixels which means the player has played optimally and earned the same number of coins as black pixels. Typically, though, the game would end before the player has used all of the predetermined number of black pixels in lines.

Note that the number of black pixels is determined based upon a theoretical return to player of the game. For example, if the player bets 20 coins to play the game (e.g., $20 if each coin represents one dollar) and the return to player is 95%, then the average (expected) number of coins the player should win would be 19. However, a random distribution would actually make it possible that more coins would be won by the player. For example, Table I represents a probability distribution for a bet of 10 coins. For example, a player would have a 5% probability of having 2 black pixels in the game, a 5% probability of having 4 black pixels in the game, an 8% probability of having 5 black pixels in the game, etc. The expected value for the distribution in Table I is a 95% return to player (sum of probability*coins). The player typically would not know how many black pixels will be available to him during the game, but it would typically be predetermined. At the end of the game, the player can then be informed how many black pixels were assigned to the game. Note that if the player has utilized all of the black pixels in the game then the game play continues so long as the player has a valid move but the player will not receive any more black pixels. Note also that if the player has achieved optimal play of the game (earned as many coins as black pixels) then no more black pixels would also be available the player in the game (any black pixels that would have been available to the player would become gray (standard) pixels).

TABLE I

| Probability | coins |
|---|---|
| 5% | 2 |
| 5% | 4 |
| 8% | 5 |
| 10% | 7 |
| 15% | 8 |
| 30% | 9 |
| 10% | 13 |
| 10% | 14 |
| 5% | 18 |
| 1% | 25 |
| 1% | 35 |

Note that during initialization of a new game, a new set of three unassigned pieces can be randomly determined (or alternatively unassigned pieces can all be retrieved from a predetermined list of pieces to be used which includes their color). These unassigned pieces are displayed below the grid.

From operation 2900, the method proceeds to operation 2901, which displays the game grid (see FIG. 2) and also (unassigned) pieces below the grid which are to be placed in the grid. Note that to the left of the pieces is a rotate button 201 which is used when the player wants to rotate one of the pieces. In order for the rotate button 201 to be active, the button 201 must first be filled. The rotate button 201 gets filled by earning points (as discussed herein). If the rotate button 201 is empty, it would take 300 points earned in order to fill the rotate button 201 and hence activate it for use. Once the rotate button is filled, additional points earned by the player have no effect on the rotate button 201. The player will ultimately select one of these pieces to place in a player-selected location in the grid. The overall goal of the game is for the player to place as many of these pieces as the player can and form as many lines as the player can before the player can no longer make a move (which ends the game).

From operation 2901, the method proceeds to operation 2902, which determines whether the player selects to rotate a piece. The player selects to rotate a piece by pressing the rotate button. The rotate button must also be filled in in order for the rotate button to be able to be activated. If the player presses the rotate button but the rotate button is not filled in, then the rotation will not be operative and the method will not proceed to operation 2903. If the player activates the rotate button 201, then the rotate button is emptied and would not be active again until the player earns another 300 points.

If in operation 2902, the player selects to rotate a piece (and the rotate button 201 is filled in) then the method proceeds to operation 2903. The player can then select a piece (out of the three shown) to rotate, and the player can select to rotate that piece 90 degrees as many times as the player wishes. The player can then place the rotated piece (in operation 2904) onto the grid (in any location on the grid the player wishes). Once the player utilizes the rotate function the rotate button 201 is emptied (all white again) so the rotate button 201 starts all over again being filled before it is active again.

From operation 2902 or 2903, the method proceeds to operation 2904 in which the player places a selected piece onto the grid in any location the player wishes. However, the player is not allowed to place a piece which covers any part of the grid that already has a piece there.

After a player places a piece in 2904, the player is entitled to earn points for placing each piece. The player would earn 10 points for each piece placed on the grid. Note that if the piece placed was a rotated piece, then the player would earn 100 points. Note also that the player would earn 250 points after placing a set of three shapes (that appeared under the grid together) if the player completed the placement of the last set of three shapes faster than the time it took the player to place the prior set of three shapes.

From operation 2904, the method proceeds to operation 2905, which determines whether a line is formed on the grid. For a line to be formed, all of the pixels in a horizontal or vertical direction on the grid must be filled in (e.g., 8-pixel line). It does not matter whether the line is formed using mixed colors (except of course for white which represents empty space), it still counts as a line.

If in operation 2905, no line is formed after the piece is placed in operation 2904, the method proceeds to operation 2907.

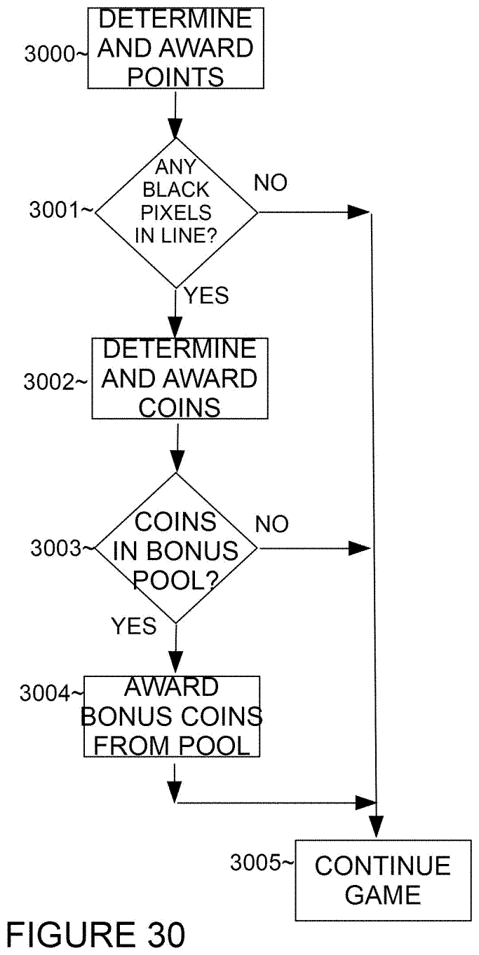

If in operation 2905, a line is formed, then the method proceeds to operation 2906. In operation 2906, the line formed is removed (erased to show white pixels) and an award is awarded to the player. The award can comprise points and/or coins. FIG. 30 is performed now as FIG. 30 illustrates how the award is determined.

From operations 2905 or 2906, the method proceeds to operation 2907, which determines whether there are any pieces left to place (shown under the grid). If there are no pieces left to place, then the method proceeds to operation 2908, which displays three new random pieces under the grid. Alternatively, in operation 2908, the pieces (and their colors) used can all be predetermined and retrieved from a queue to be displayed.

From operations 2907 or 2908, the method proceeds to operation 2909, which determines whether there are any valid moves let on the grid. If the player is able to place one of the displayed pieces (under the grid, but pieces already placed in the grid cannot be moved) anywhere on the grid then the player has a valid move left. If none of the pieces displayed under the grid can be placed at any location in the grid in their current state (rotational position) but if the rotate button is active (filled) and after rotation (any number of times) the piece can then be placed on the grid then this would be considered a valid move. If there is any way one of the displayed unassigned pieces (the pieces displayed under the grid) can be placed in the grid, then there is a valid move left. If none f the displayed pieces can be placed in the grid (including using rotation if available) then there are no valid moves left.

If there is at least one valid move left, then the method returns to operation 2901 and the game play continues.

If in operation 2909 there is no valid move left, then the method proceeds to operation 2910, which awards and final awards to the player. For example, a bonus amount of points can be awarded to the player based on how many moves the player has made or any other criteria.

From operation 2910, the method proceeds to operation 2911, which determines whether the player played an optimal game. An optimal game is if the player earned as many coins during play of the game as the number of black pixels in the pieces used which was determined at the start of the game. For example, if at the start of the game the number of black pixels was randomly determined to be 12 (it can, for example, be a random number determined from 10 to 50 (or other range)), then the optimal play of this particular game would earn the player 12 coins. If the player has earned less than 12 coins during play of the game then the player has not played optimally. If the player has earned 12 coins during play of the game then the player has played optimally. Typically, the player would not be able to earn more coins than the number of black pixels determined at the start of the game.

If in operation 2911, the player has played optimally, then the method proceeds to operation 2913, wherein the game ends. Of course, the player is free to make a new wager and begin a brand new game (returning to operation 2900). Of course, the number of coins the player has won during play of the game is added to the player's credit meter and can be cashed out at the player's discretion.

If in operation 2911, it is determined that the player has not played optimally, then the method proceeds to operation 2912 wherein the difference between the number of coins the player won during this game and the optimal number of coins (the number of black pixels available in the game) is determined (total black pixels available to player minus coins the player has actually won). This different (“error”) is then added to an error pool so it can be redistributed to other players. For example, if there were 12 black pixels available in the game, and the player only won 5 coins, then the error would be 12−5=7 coins.

When the game ends, the amount of points the player earned can be stored in a database (game server) and players can be ranked based on their point scores.

FIG. 30 is a flowchart illustrating an exemplary method of determining awards for forming a line, according to an embodiment.

The method starts with operation 3000, which determines and awards points based on a cleared line. Table II represents points earned for clearing a respective number of lines with one piece placement on the grid.

TABLE II

| Lines cleared | points |
|---|---|
| 1 | 100 |
| 2 | 300 |
| 3 | 600 |
| 4 | 1000 |
| 5 | 1500 |
| 6 | 2100 |

Thus, if a player places a piece and it clears a single line, the player would get 100 points for clearing the line (plus 10 points for placing the piece in operation 2904). Note that if an entire black shape is cleared immediately after it is placed on the grid then the player earns 1000 bonus points. In addition, if the player clears the entire grid (game board) then the player earns 1000 bonus points.

From operation 3000, the method proceeds to operation 3001, in which it is determined whether the line cleared includes any black pixels. If not, then the method proceeds to operation 3005 which continues the game (proceeds to operation 2907).

If in operation 3001, it is determined that the line cleared does include at least one black pixel, then the method proceeds to operation 3002. In operation 3002, it is determined how many coins to award the player. The total number of black pixels recently cleared in the line (or multiple lines cleared) is the number of coins awarded to the player.

From operation 3002, the method proceeds to operation 3003, which determines whether there are coins in the bonus pool. If not, then the method proceeds to operation 3005. If there are coins in the bonus pool, then the method proceeds to operation 3004.

Note that the bonus pool is maintained among all players even though all players are playing remotely and can be playing for different denominations. Typically, a single bonus pool is maintained for the game, so regardless of how many players are playing the game (e.g., 1 to 100 or more), the bonus pool is “rolling”. That is, it is continuously changing (either coins are being taken out to award to players as a bonus and/or coins being added when a player's game ends without the player playing optimally).

In operation 3004, a bonus award (in coins) is determined and taken (deducted) from the bonus pool (or pool for short). The bonus award cannot be greater than the amount of coins in the bonus pool. The number of bonus coins awarded can be chosen randomly and can be determined using a probability distribution or algorithm.

For example, in one embodiment, a bonus multiplier is determined (which can be determined as a random number from 2 to 4), and the number of cons the player has earned in operation 3002 is multiplied by the bonus multiplier and also awarded to the player as a bonus. For example, if two black pixels were removed from the line formed and thus in operation 3002 two coins are awarded, then in operation 3004 a random multiplier of 3 is determined (of course it can be determined as other numbers as well) which is multiplied by 3=6 coins. Thus, in addition to the 2 coins awarded in operation 3002, the player is also awarded an additional 6 bonus coins for a total of 8 coins.

Note that many other algorithms can be used to determine bonus coins awarded from the bonus pool as well. For example, the number of bonus coins can be a random percentage (e.g., 5 to 20) of the amount of coins in the bonus pool.

From operation 3004, the method proceeds to operation 3005, which continues the game (proceeds to operation 2907).

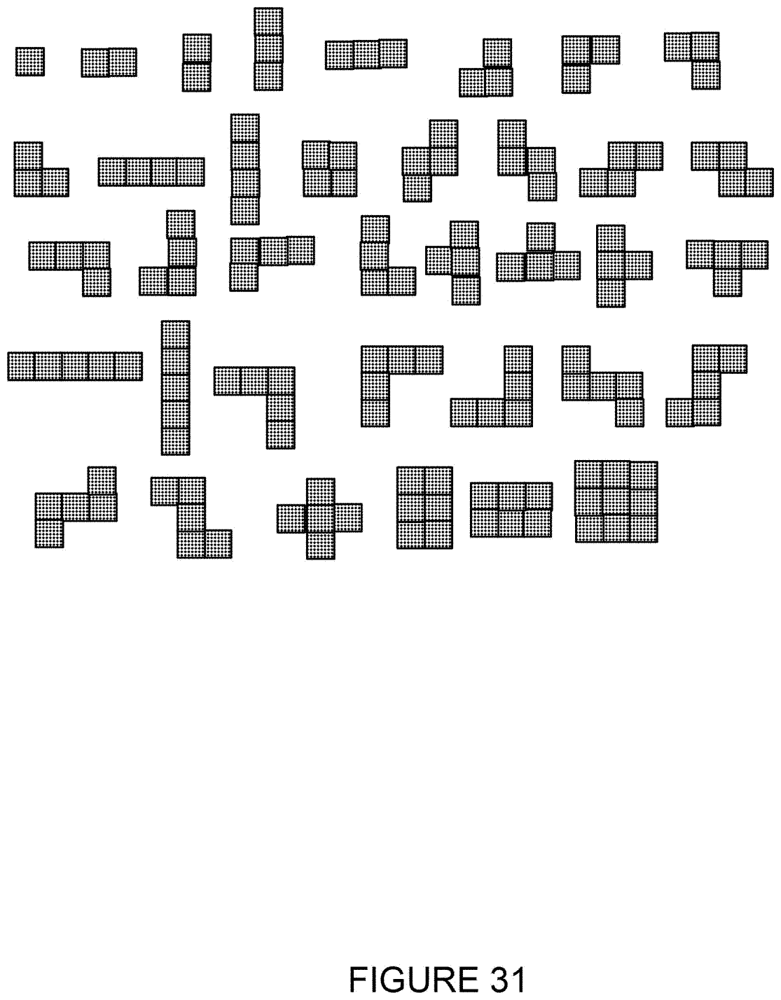

FIG. 31 is a drawing of a set of potential shapes, according to an embodiment;

Shown are all of the possible shapes that the unassigned pieces (shapes) are selected randomly from that the player has to place on the grid. The same shapes are used regardless of the color (gray or black). As stated herein, gray pixels can only earn the player points, but black pixels can earn the player points and coins.

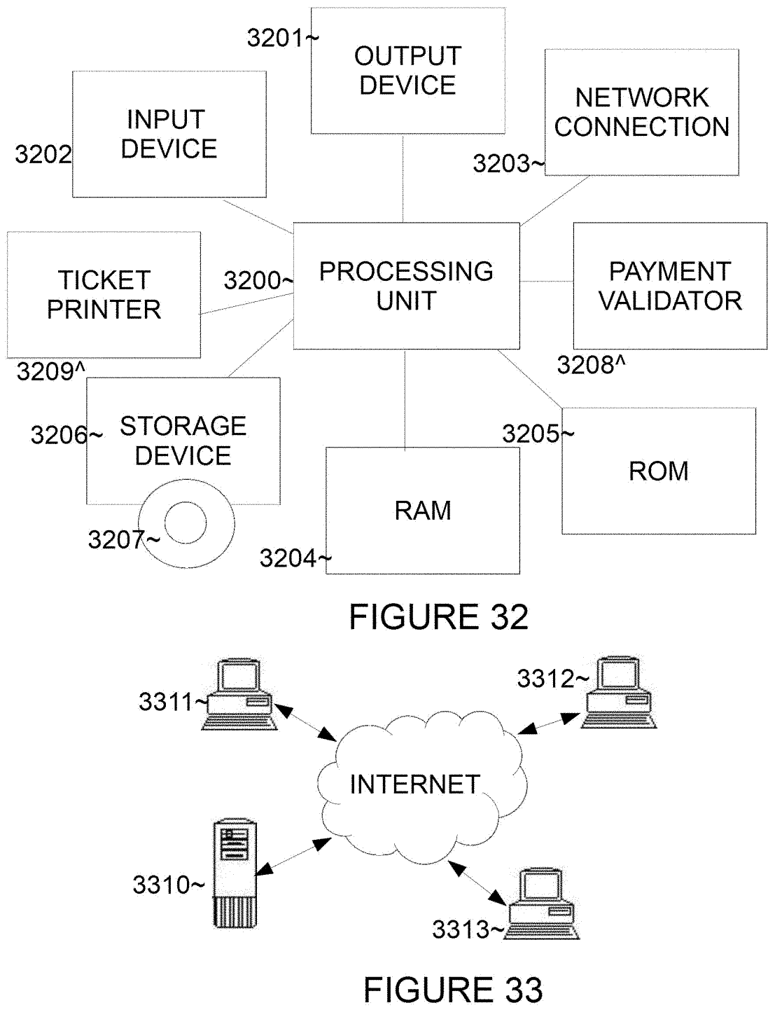

FIG. 32 is a block diagram illustrating exemplary hardware that can be used to implement the game described herein, according to an embodiment. The hardware in FIG. 32 can be used to implement a computer implementing the game described herein (e.g., implement an online casino utilizing real money wagers and payouts) and/or a server that is serving the game to a computer which is displaying the game to a player. Such a server can optionally interface with a social networking site (e.g., FACEBOOK, MYSPACE, etc.) that is used to coordinate the entire game and communicate with the players as well as a server used by the social network site. The hardware can also be, for example, an electronic gaming machine (EGM) used in casinos such as a video slot machine. The hardware can also be a server implementing an online casino which servers a large number (e.g., 1-1000 or more) of simultaneous remote players as well as a larger number of players who have an account with the online casino who many not be playing at a particular time. The hardware can also be a personal computer or personal computing device (e.g., laptop, desktop, cell phone, tablet, etc.) playing the game using the Internet. The hardware can also be any other type of device, working individually or in conjunction with other devices.

A processing unit 3200 (such as a microprocessor and any associated components) is connected to an output device 3201 (such as an LCD monitor, touch screen, CRT, etc.) which is used to display to the player any aspect/output/state of the method, and an input device 3202 (e.g., buttons, a touch screen, a keyboard, mouse, etc.) which can be used to input from the player any decision/input made by the player. All methods described herein can be performed by the processing unit 3200 by loading and executing respective instructions which are programmed accordingly. Multiple such processing units can also work in collaboration with each other (in a same or different physical location). The processing unit 3200 can also be connected to a network connection 3203, which can connect the electronic gaming device to a computer communications network such as the Internet, a LAN, WAN, etc. The processing unit 3200 is also connected to a RAM 3204 and a ROM 3205. The processing unit 3200 is also connected to a storage device 3206 which can be a disk drive, DVD-drive, CD-ROM drive, flash memory, etc. A non-transitory computer readable storage medium 3207 (e.g., hard disk, CD-ROM, solid state drive, or any other non-transitory medium which can store computer readable instructions), can store a computer readable program which (when executed) can control (and cause) the electronic device (and/or the processing unit 3200) to perform any and all of the methods described herein, and can be read by the storage device 3206 and written to by the storage device 3206.

Note that all aspects of the game can be displayed on the output device 3201. For example, each time points are earned, coins are earned, or any game state changes, etc., this would typically be displayed on the output device 3201 (including any relevant details thereof).

The processing unit 3200 can also be connected to a payment validator 3208. The payment validator can be a bill acceptor which accepts currency, identifies it as being valid (typically by using an optical scanner), and then credits (“credits” as used herein can also be synonymous with coins) the inserted bill amount to the machine (for example inserting a $10 bill will credit the machine with $10 in credits). These credits can be used to play the games (e.g., pay for a spin). The bill acceptor can also accept cashless tickets as part of a ‘ticket-in-ticket-out” system, in which tickets (cashless vouchers) have cash value and can be inserted into the payment validator 1208. The validator 3208 validates the ticket (typically be optically scanning a bar-code), communicating electronically with a casino database to verify the ticket is authentic, and once authenticated then crediting the machine with the respective amount of credits. The payment validator 3208 can also include a card reader which can read cards (e.g., with a magnetic stripe or other electronic encoding) so that an account number can be accessed. The cards can be a credit card, player loyalty card, specific casino payment card, or any card that can provide electronic access to a monetary amount owned by the player (owner of the card) which the player can utilize for depositing money and then playing the machine. If such a card is used, then the player can optionally enter (using a keypad) an amount the player wishes to withdraw from the account associated with the card to credit to the machine. The player can also the card in this matter to request that the machine electronically transfer any credits on the machine (e.g., credits) to the player's account associated with the card.

The processing unit 3200 can also be connected to a ticket printer 3209 which can print tickets (cashless vouchers). When the player cashes out on the machine (indicated to the machine that the player wishes to cash out and terminate by, typically by pressing a button), a ticket is printed by the ticket printer 1209 which carries (can be redeemed for) the amount of credits left on the machine in the credit meter. This ticket can then be used to play other machines in the casino by inserting them into that machine's payment validator. The ticket can also be used to redeem for cash by inserting it into a ticket redemption machine (kiosk) which receives a ticket, validates it (typically by scanning the barcode), and then dispenses an identical amount of cash to what the ticket's value is. Note that at any time during play, the player can cash out (typically by pressing a cash out button) all of the credits shown in the credit meter into numerous forms which are cash or can be redeemed by cash by the player, such as cash, coins, a cashless ticket, an electronic payment, crypto-currency, etc.

While one processing unit is shown, it can be appreciated that one or more such processor (processing units) can work together (either in a same physical location or in different locations) to combine to implement any of the methods described herein. Programs and/or data required to implement any of the methods/features described herein can all be stored on any non-transitory computer readable storage medium (volatile or non-volatile, such as CD-ROM, RAM, ROM, EPROM, microprocessor cache, etc.)

Note that if the embodiments described herein are implemented as an electronic gaming machine (EGM) then it may be necessary for the machine to be approved by the regulatory authorities (e.g., the Nevada State Gaming Commission) to ensure they have a suitable return to player (RTP) and are honest. Such approval includes inspection of the hardware, software, play-testing, evaluation of the random number generators (either hardware or software), etc. Once the machine has been approved from a rigorous testing will it be officially approved by a regulatory authority and then can appear in that jurisdiction's gaming floor.

FIG. 33 is a network diagram showing a network structure for an online casino and players, according to an embodiment.

A computer communications network (such as the Internet) can be used to connect an online casino server 3310 which can host and serve an online casino and implement a game as described herein via the internet. Note that while FIG. 33 shows only one online casino server 3310, the casino server 3310 can encompass numerous servers all cooperating with each other (whether in the same physical location or not). The casino server 3310 communicates with players 3311, 3312, 3313 through the Internet (or other computer communication network) and can remotely implement any of the methods/games described herein by executing computer code programmed accordingly. As such, the methods/games described herein can be offered at an online casino for credits which are exchangeable for real money.

All components herein can be distributed across different such components as needed. For example, a single server as mentioned herein can be distributed across numerous different servers and locations. A processor (or processing unit) can also be distributed across multiple processors in a same or different computer (at a same or different location). The electronic components described herein represent an abstraction but it can be appreciated that the computer systems implementing the methods herein can be more numerous and interconnected than illustrated herein.

If a player is playing the game described herein on a social networking site or other type of hosted environment, then the player's computer would cooperate with the social networking server in order to present the game to the player. The player's computer would perform the instructions necessary to display the game while the remote server can determine the results (e.g., the final arrangement) and communicate this result via the Internet to the player's computer so that the player's computer can accurately display the result. The remote server may track and account for all credits wagered and won/lost while the player's computer can display the amount of credits owned or won at the direction of the remote server so the player cannot tamper with these amounts. All games described herein are considered to be played on the site described herein.

Any description of a component or embodiment herein also includes hardware, software, and configurations which already exist in the prior art and may be necessary to the operation of such component(s) or embodiment(s).

Further, the operations described herein can be performed in any sensible order. Any operations not required for proper operation can be optional. Further, all methods described herein can also be stored on a computer readable storage to control a computer. All variations and features described herein can be combined with any other features described herein without limitation. Note that “wager” and “bet” as used herein are generally synonymous with each other.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. An apparatus to implement a game, the apparatus comprising:
an electronic output device and an electronic input device;
an electronic storage device configured to read a non-transitory computer readable storage medium which stores computer readable instructions;
at least one processing unit connected to the electronic output device, the electronic input device, and the electronic storage device, the at least one processing unit configured to utilize the electronic storage device to read and execute the computer readable instructions which are programmed to cause the at least one processing unit to:
receive a wager from a player in credits;
display a grid;
show at least one unassigned piece out of a set of available pieces, each of the at least one unassigned piece being a color in a set comprising a first color and a second color;
enable the player to select a selected piece out of the at least one unassigned piece and place the selected piece on the grid, upon a line on grid being formed then awarding credits based on a number of pixels in the line of a first color, and removing the line; and
continuously perform the display, show, and enable operations until the game ends.

2. The apparatus as recited in claim 1, wherein the computer readable instructions are further programmed such that when the line is formed awarding points.

3. The apparatus as recited in claim 1, wherein the computer readable instructions are further programmed such that the player has an ability to rotate the selected piece before placing it on the grid.

4. The apparatus as recited in claim 3, wherein the computer readable instructions are further programmed such that the player is required to accumulate points of at least a predetermined amount of points before the player has the ability to rotate the selected piece, and upon rotation the accumulated points is reset to zero.

5. The apparatus as recited in claim 1, wherein the computer readable instructions are further programmed such that when the game ends, an error is computed as an optimal amount of credits potentially earned minus an actual amount of credits won in the game, and the error is contributed to an error pool.

6. The apparatus as recited in claim 5, wherein the computer readable instructions are further programmed such that upon the line on the grid being formed, a bonus amount of credits is awarded to the player from the error pool.

7. The apparatus as recited in claim 1, wherein the computer readable instructions are further programmed such that an amount of pixels of the first color available to the player in the game is randomly predetermined.

8. The apparatus as recited in claim 1, wherein the computer readable instructions are further programmed such that the line on the grid formed earns the player points and earns the player credits when at least one pixel of the first color is in the line.

9. The apparatus as recited in claim 1, wherein the computer readable instructions are further programmed such that the game ends when none of the at least one unassigned piece fits on the grid.

10. The apparatus as recited in claim 1, wherein the computer readable instructions are further programmed such that upon multiple lines being formed upon placement of the selected piece then more points are awarded to the player than when a single line is formed.

11. A method to implement a game, the method comprising:
providing an electronic output device and an electronic input device;
providing an electronic storage device configured to read a non-transitory computer readable storage medium which stores computer readable instructions;
providing at least one processing unit connected to the electronic output device, the electronic input device, and the electronic storage device;
executing the computer readable instructions by the at least one processing unit which cause the at least one processing unit to perform:
receiving a wager from a player in credits;
displaying a grid;
showing at least one unassigned piece out of a set of available pieces, each of the at least one unassigned piece being a color in a set comprising a first color and a second color;
enabling the player to select a selected piece out of the at least one unassigned piece and place the selected piece on the grid, upon a line on grid being formed then awarding credits based on a number of pixels in the line of a first color, and removing the line; and
continuously perform the displaying, showing, and enabling operations until the game ends.

12. The method as recited in claim 11, further comprising awarding points when the line is formed.

13. The method as recited in claim 11, further comprising allowing the player to rotate the selected piece before placing it on the grid.

14. The method as recited in claim 11, further comprising requiring the player to accumulate points of at least a predetermined amount of points before the player has the ability to rotate the selected piece; and upon rotation resetting the accumulated points to zero.

15. The method as recited in claim 11, further comprising upon the game ending, computing an error as an optimal amount of credits potentially earned minus an actual amount of credits won in the game; and contributing the error to an error pool.

16. The method as recited in claim 11, further comprising upon the line on the grid being formed, awarding a bonus amount of credits to the player from the error pool.

17. The method as recited in claim 11, further comprising randomly determining an amount of pixels of the first color available to the player in the game.

18. The method as recited in claim 11, further comprising when at least one pixel of the first color is in the line on the grid formed, awarding the player points and also awarding the player credits based on how many pixels of the first color is in the line.

19. The method as recited in claim 11, further comprising determining that none of the at least one unassigned piece fits on the grid and then based on the determining, ending the game.

20. The method as recited in claim 11, further comprising determining that multiple lines are formed upon placement of the selected piece, and awarding more points to the player than would be awarded to the player when a single line is formed.
